(19) United States
(12) Patent Application Publication
(10) Pub. No.: US 2007/0188008 A1
(43) Pub. Date: Aug. 16, 2007

(54) Electric lift

(75) Inventor: Christopher K. Furman, Augusta, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/355,373

(22) Filed: Feb. 16, 2006

(51) Int. Cl. B60P 1/28

(52) U.S. Cl. 298/17 R

(57) ABSTRACT

A cargo bed lift assembly for a light-weight utility vehicle. The lift assembly includes a bed platform coupled to an underside of a light weight utility vehicle cargo bed. An electric actuator can be removably mounted at an upper end to the bed platform and removably mounted at a lower end to a vehicle frame front cross-member. Additionally, a frame brace can be removably coupled at a lower end to the vehicle frame front cross-member and removably coupled at an upper end to a vehicle frame rear cross-member. Thus, the actuator is a front, center mounted actuator that can be electrically controlled to lift and hold the front of the cargo bed at any desired position between and inclusive of a non-deployed position and a fully deployed position.

### FIELD

The present disclosure relates to an electric lift for a utility vehicle.

### BACKGROUND

Many light weight utility vehicles have ‘dump’ cargo beds that can be tilted so that cargo carried within the bed can be dumped or deposited easily without the need to manually unload the cargo. Generally, such dump cargo beds are manually operated dump beds that are difficult and cumbersome to operate with large heavy loads of cargo.

### SUMMARY

In various embodiments of the present disclosure, a cargo bed lift assembly for a light-weight utility vehicle is provided. In some implementations, the lift assembly includes a bed platform coupled to an underside of a light weight utility vehicle cargo bed. An electric actuator can be removably mounted at an upper end to the bed platform and removably mounted at a lower end to a vehicle frame front cross-member. Additionally, a frame brace can be removably coupled at a lower end to the vehicle frame front cross-member and removably coupled at an upper end to a vehicle frame rear cross-member. Thus, the actuator is a front, center mounted actuator that can be electrically controlled to lift and hold the front of the cargo bed at any desired position between and inclusive of a non-deployed position and a fully deployed position. The frame brace distributes any load on the actuator between the upper and the lower cross members and prevents twisting of the lower cross-member during operation of the actuator.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a partial isometric view of a utility vehicle including a tiltable cargo bed in accordance with various embodiments of present disclosure;

FIG. 2 is a side view of the cargo bed shown in FIG. 1 in a non-deployed position;

FIG. 3 is a side view of the cargo bed shown in FIG. 1 in a fully deployed position;

FIG. 4 is an exploded isometric view of an electric lift assembly, shown in FIG. 1, in accordance with various embodiments of the present disclosure; and

FIG. 5 is an isometric view of the electric lift assembly shown in FIG. 4 connected to an underside of the cargo bed shown in FIG. 1.

### DETAILED DESCRIPTION

The following description of various embodiments is merely exemplary in nature and is in no way intended to limit the present teachings, application, or uses.

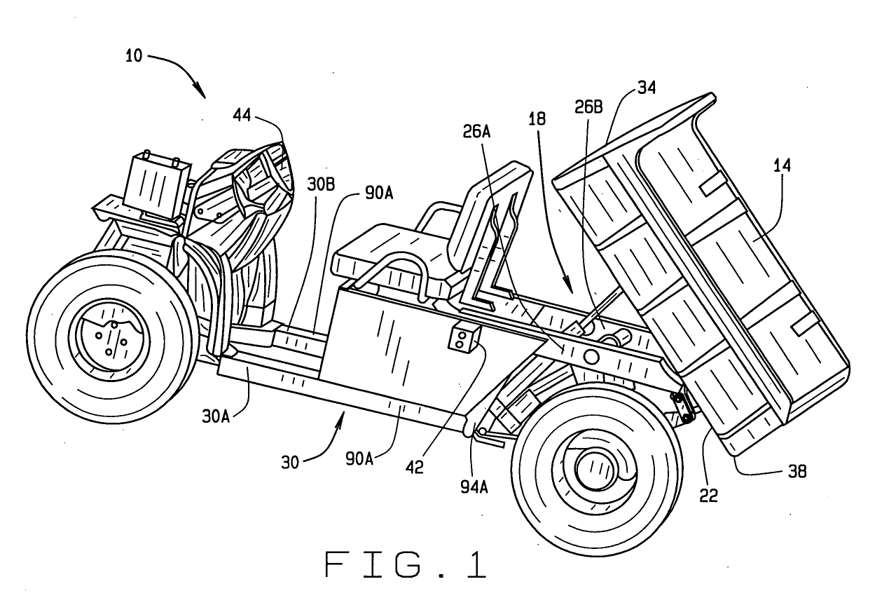

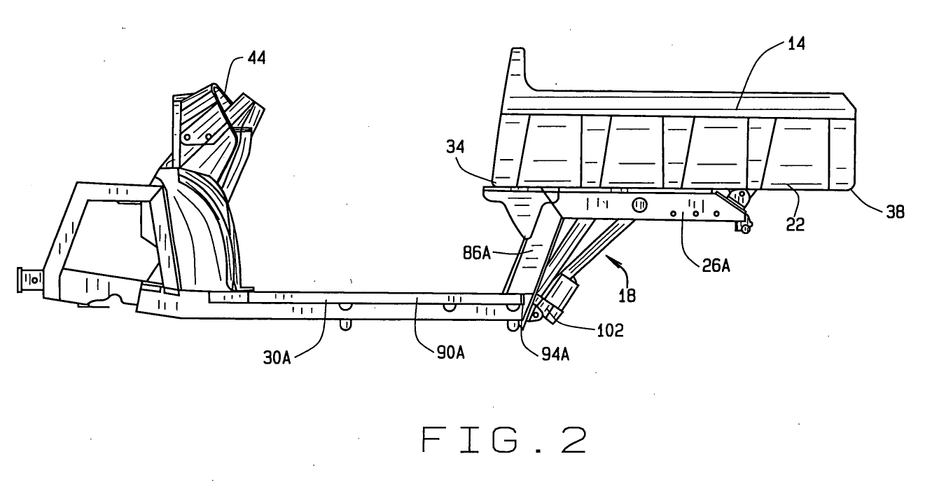

Referring to FIGS. 1, 2 and 3, in various embodiments, a utility vehicle 10 comprises a tiltable cargo bed 14, sometimes referred to in the art as a dump cargo bed. The cargo bed 14 comprises any enclosure or structure suitable for holding and/or hauling any type of cargo, e.g., sand, dirt, gravel and any other material, apparatus, equipment, machinery or device. In various embodiments, the cargo bed 14 is a one-piece molded structure including a front wall, two sidewalls and a bottom. The cargo bed 14 is controllably transitional between a non-deployed position and a fully deployed position, via an electric lift assembly 18. When in the non-deployed position, a bottom 22 of the cargo bed 14 is in a substantially parallel orientation with upper rear sections 26A and 26B of a vehicle frame 30, as shown in FIG. 2. The upper rear section 26A comprises the upper rear section of a longitudinal driver-side frame beam 30A and upper rear section 26B comprises the upper rear section of a longitudinal passenger-side frame beam 30B.

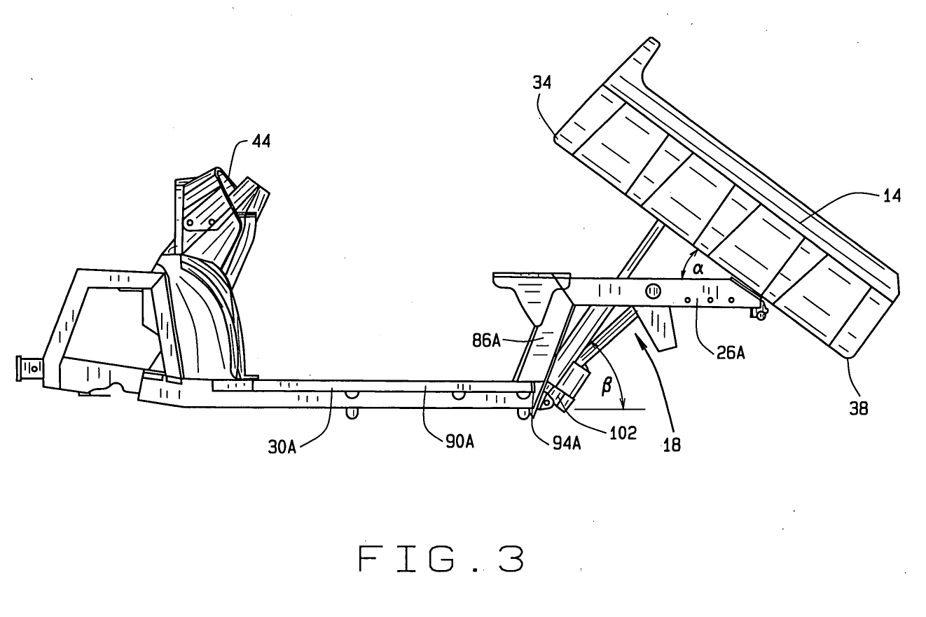

When in the fully deployed position, the cargo bed 14 has been transitioned by the lift assembly 18 such that a front end 34 of the cargo bed is elevated to be substantially higher than a back end 38 of the cargo bed 14, as shown in FIG. 3. More particularly, as the lift assembly 18 transitions, i.e., lifts the front end 34, the cargo bed 14 angle α, formed between the frame upper rear sections 26A and 26B, increases from effectively 0° to a maximum deployment angle when the cargo bed is fully deployed. In various embodiments, the maximum deployment angle can be approximately 45° to 55°, for example 50°. When in the fully deployed position, any cargo being carried in the cargo bed 14 will be effectively expelled, e.g., dumped, from the cargo bed 14 due to gravitational forces. Operation of the lift assembly 18 and, accordingly, raising and lowering of the cargo bed 14, is controlled by a control device 42.

Although the control device 42 is shown in FIG. 1 as being mounted on a side of the vehicle 10, it should be understood that the control device 42 can be mounted, or installed, in any suitable location of the vehicle 10. For example, the control device 42 could be installed in an instrument panel 44 of the vehicle 10. Using the control device 42, the lift assembly 18 can controllably deploy the cargo bed 14, i.e., raise the front end 34, to any angle α between effectively 0° and the maximum deployment angle. For example, the lift assembly 18 can be controlled to deploy the cargo bed 14 to an angle α of 10°, 21°, 35° or any other angle α and hold the cargo bed 14 at the particular angle α until commanded by the control device 42 to transition the cargo bed 14 to a greater or lesser angle α.

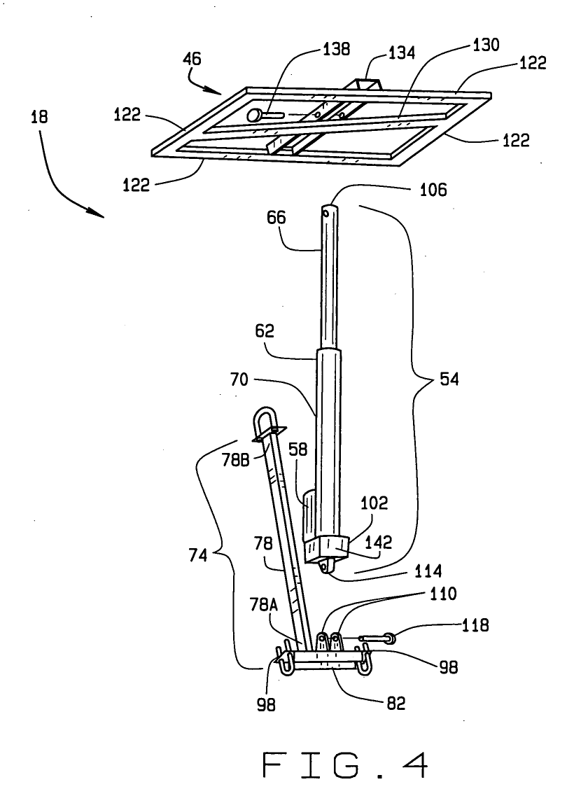

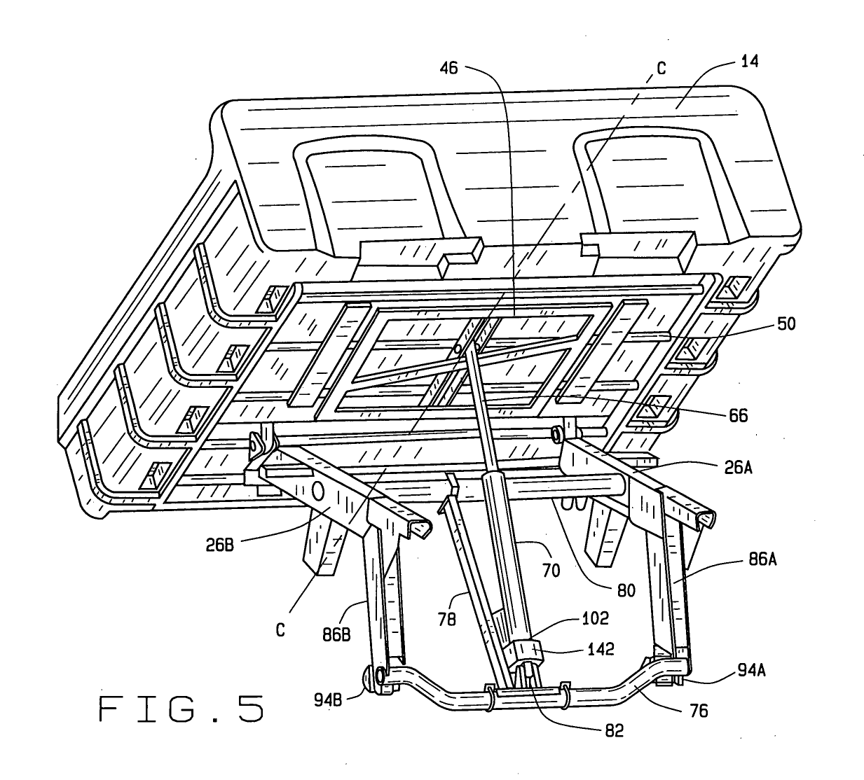

Referring now to FIGS. 4 and 5, the lift assembly 18 can comprise a bed platform 46 connected to an underside 50 of the cargo bed 14. The bed platform can be connected to the underside 50 using any suitable fastening means, such as nuts and bolts, rivets or screws. The lift assembly 18 additionally can comprise an electric actuator 54 removably and pivotally coupled to the bed platform 46. The electric actuator 54 comprises a motor 58 and a lift rod and canister (LRC) assembly 62 connected to the motor 58. The LRC assembly 62 comprises a lift rod 66 within a lift canister 70. The motor 58 operates in response to commands from the control device 42 to transition, that is, extend and retract, the lift rod 66 within the lift canister 70. Accordingly, when actuator 54 is pivotally coupled to the bed platform 46, the motor 58 operates to controllably extend the lift rod 66, thereby raising the front end 34 of cargo bed 14, and controllably retract the lift rod 66, thereby lowering the front end 34. In various implementations, the LRC assembly 62 is a screw drive type assembly such that the lift rod 66 is transitioned via a threaded drive rod subassembly (not shown) within the LRC assembly 62. In various embodiments, the electric actuator 54 can be a 12 volt DC unit that is operationally controlled by the control device 42 comprising a single double pole double throw momentary rocker switch. Actuator not limited to screw type electric actuator and could be hydraulic, pneumatic or any other lifting device.

In various embodiments, the lift assembly 18 can further comprise a frame brace 74 removably connected between a frame front cross-member 76 and a frame rear cross-member 80. In addition to the rear upper section 26A, the driver-side frame beam 30A comprises a transitional frame section 86A connecting a lower platform section 90A to the rear upper section 26A. Similarly, the passenger-side frame beam 30B comprises a transitional frame section 86B connecting a lower platform section 90B to the rear upper section 26B. The frame front cross-member 76 is connected between the driver-side and passenger-side frame beams 30A and 30B at lower ends 94A and 94B of the respective transitional sections 86A and 86B. In various implementations, the cargo bed 14 is pivotally mounted to the frame 30 at or near the rear upper sections such that when the cargo bed 14 is in the non-deployed position, the cargo bed front end 34 is approximately adjacent, i.e., substantially directly above the junction of lower ends 94A and 94B and the respective platform sections 90A and 90B. Thus, when the cargo bed 14 is in the non-deployed position, the cargo bed front end 34 is approximately adjacent, i.e., substantially directly above the front the cross-member 76.

The frame rear cross-member 80 is connected between driver-side and passenger-side frame beams 30A and 30B at approximately a mid-point of the rear upper sections 26A and 26B. The front and rear cross-members 76 and 80 provide structural support, rigidity and stability to the vehicle frame 30 and also distribute loads put on the vehicle frame 30. The frame brace 74 comprises a leg portion 78 and a foot portion 82 connected at a lower end 78A of the leg portion 78. The leg portion can be constructed of any suitable structurally strong, substantially rigid and durable material and form, e.g., steel or aluminum box tubing. The foot portion 82 can be connected to the end of the leg portion using any suitable means, such as welding, bolting, riveting or screwing. The frame brace 74 can be removably coupled at an upper end 78B to the rear cross-member 80. The foot portion 82 can be removably coupled to the front cross-member 76. The foot portion 82 provides stability for the frame brace 74 and distributes loads applied to the frame brace 74 across the front cross-member 76. In various embodiments, the foot portion 82 can comprise a ‘hat channel’ that substantially conforms to the shape of the front cross-member 76. Thus, the hat channel foot portion 82 substantially conforms and mates with a surface of the front-cross member 76. Additionally, the foot portion 82 can comprise coupling tabs 98 at opposing ends that are utilized to removably couple the foot portion, and thus the frame brace, to the front cross-member 76. For example, the coupling tabs can include holes through which ends of a U-bolt placed around the front cross-member 76 can be inserted. Threaded nuts can then be threaded on to the U-bolt ends to securely, but removably, connect the foot portion 82 to the front cross-member 76. Similarly, a U-bolt can be utilized to securely, but removably, connect the frame brace upper end 78B to the rear cross-member 80.

A lower end 102 of the actuator 54 can be removably connected approximately at a mid-point of the front cross-member 76 and an upper end 106 of the actuator can be removably connected to the bed platform 46. More particularly, the foot portion 82 of the frame brace 74 can comprise a pair of opposing clevis joint arms 110 adapted to receive therebetween a clevis joint tongue 114 formed at or coupled to the lower end 102. A lower clevis dowel pin 118 can be inserted through aligning holes in the clevis joint arms 110 and a hole in the clevis joint tongue 114. Thus, a lower clevis joint including the arms 110, the tongue 114 and the lower dowel pin 118 can be implemented to pivotally and removably couple the actuator 54 to the foot portion 82 and thus, to the front cross-member 76. Furthermore, the foot portion 82 can be coupled to the front cross-member 76 such that the lower clevis joint is positioned approximately at the mid-point of the front cross-member 76.

In various embodiments, the bed platform 46 can comprise a plurality of frame rails 122 connected to form a platform frame. The frame rails 122 can be constructed of any suitable structurally strong, substantially rigid and durable material and form, e.g., steel or aluminum box tubing. Additionally, the frame rails can be connected in any suitable fashion, e.g., welding or bolting, to form a frame having any geometric shape, e.g., a square, a rectangle, a triangle or a circle, suitable to distribute a force applied by the actuator 54 across a large portion of the cargo bed underside 50. FIGS. 4 and 5 illustratively show the bed platform 46 having a substantially square shape sized to fit between the driver-side and passenger-side frame beam rear sections 26A and 26B while spanning the largest possible area of the cargo bed underside 50. Additionally, the bed platform can include a racking rail 130 to rack the frame formed by the frame rails 122. Similar to the frame rails 122, the racking rails 130 can be constructed of any suitable structurally strong, substantially rigid and durable material and form, e.g., steel or aluminum box tubing. Furthermore, in various embodiments, the bed platform 46 includes a center C-channel 134 that substantially aligns with a longitudinal center line C of the cargo bed 14 when the bed platform is connected to the underside 50. The center C-channel 134 can be constructed of any suitable structurally strong, substantially rigid and durable material, e.g., steel or aluminum.

To removably and pivotally couple the actuator 54 to the bed platform 46, in some implementations, an upper clevis joint is formed between the actuator upper end 106 and the center C-channel. Particularly, an upper clevis dowel pin 138 can be inserted through aligning apertures in opposing legs of the center C-channel 134 and an aperture in the actuator upper end 106, i.e., an aperture in the upper end of the lift rod 66. Thus, an upper clevis joint including center C-channel legs, the lift rod upper end 106 and the upper dowel pin 138 can be implemented to pivotally and removably couple the actuator 54 to bed platform 46 approximately along the longitudinal center line C of the cargo bed 14. Thus, in various embodiments, the actuator 54 is a front, center mounted actuator. That is, the actuator lower end 102 is pivotally and removably coupled to the lower cross-member 76 approximately at the mid-point of the lower cross-member 76 to position the actuator lower end adjacent, i.e., below the cargo bed front end 34. Additionally, the actuator upper end 106 is pivotally and removably coupled to the bed platform center C-channel 134 and the bed platform 46 is coupled to the cargo bed underside 50 such that the actuator upper end 106 is positioned approximately along a center line C of the cargo bed.

As described above, the frame brace 74 is connected at an upper end 78B to the rear cross-member 80 and at lower end 78B to the front cross-member 76. Connecting the frame brace 74 between the front and rear cross-members 76 and 80 distributes any load exerted on the actuator 54 by the cargo bed 14 and/or any cargo carried within the cargo bed 14 across the driver-side and passenger-side beams 30A and 30B. Additionally, connecting the frame brace 74 between the front and rear cross-members 76 and 80 reduces or substantially prevents twisting of the vehicle frame 30, i.e., the front and rear cross-members 76 and 80 and the driver-side and passenger-side frame beams 30A and 30B, when a load is applied to the front cross-member 76 by the actuator 54.

The actuator 54 is mounted between the front and rear cross-members 76 and 80 such that the actuator is oriented at an angle β relative the plane of the frame platform sections 90A and 90B. In various embodiments, the actuator 54 is mounted and angle β such that the work or force required by the actuator 54 to lift the cargo bed front end 34, and any cargo therein, is minimized. More specifically, the actuator 54 is mounted at an angle β such that throughout the range of motion of the actuator 54, the actuator 54 will exert a force on the bed platform 46 that is in a direction as close as possible to opposite the direction of the force the cargo bed 14 and cargo is exerting on the actuator. For example, the actuator 54 can be mounted such that a force required by the actuator to initially lift the cargo bed 14 is approximately 100% to 125% or 100% to 115%, of a minimal necessary amount of force needed to initially lift the cargo bed front end 34, and any cargo therein. Additionally, in various embodiments, the actuator 54 is mounted and angle β such that the angle β changes very little during the entire range of motion of the actuator 54. That is, the angle β changes very little during the process of lifting the cargo bed front end and any cargo bed contents from the non-deployed position to the fully deployed position. For example, the actuator 54 is mounted to the front and rear cross-members 76 and 80 such that the angle β changes approximately 0° to ±10°, e.g., approximately ±2°, through the entire actuator 54 range of motion. As a further example, the actuator 54 can be mounted at an angle β of between approximately 40° and 50°, e.g., approximately 45°, to minimize the force required to initially lift the cargo bed 14 and minimize the change of β throughout the range of motion for the actuator 54.

Furthermore, in various implementations, the actuator 54 comprises a gear box 142 at the actuator lower end 102 that can comprise a brake or latch mechanism to hold the actuator lift rod 66 at any desired linear translation position. Thus, the actuator 54 could be operated to lift and hold the cargo bed front end 34 at any position throughout the range of motion between and inclusive of the non-deployed position and the fully deployed position.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A cargo bed lift assembly for a light-weight utility vehicle comprising:
a bed platform coupled to an underside of a cargo bed;
an electric actuator removably mounted at an upper end to the bed platform and removably mounted at a lower end to a vehicle frame front cross-member; and
a frame brace removably coupled at a lower end to the vehicle frame front cross-member and removably coupled at an upper end to a vehicle frame rear cross-member.

2. The assembly of claim 1, wherein the bed platform comprises a center C-channel connected to the underside approximately along a longitudinal center of the cargo bed, the actuator upper end removably connected to the C-channel via a clevis joint including a dowel pin removably inserted through the actuator upper end and a pair of opposing apertures in opposing legs of the C-channel.

3. The assembly of claim 1, wherein the lower end of the frame brace comprises a hat-channel coupled to the vehicle frame front cross-member, the actuator lower end removably coupled to the hat-channel via clevis joint including a dowel pin removably inserted through the actuator lower end and a pair of opposing apertures in opposing arms of the hat-channel.

4. The assembly of claim 3, wherein the hat-channel includes a coupling tab at each of opposing ends.

5. The assembly of claim 6, wherein the actuator is mounted at an angle of approximately 40° to 50° relative to the underside of the cargo bed when the cargo bed is in a non-deployed position.

6. A cargo bed lift assembly for a light-weight utility vehicle comprising:
a bed platform comprising a center C-channel connected to an underside of a cargo bed approximately along the longitudinal center of the cargo bed;
an electric actuator removably mounted at an upper end to the bed platform approximately along a longitudinal center of the cargo bed, and removably mounted at a lower end to a vehicle frame front cross-member located below a front portion of cargo bed; and
a frame brace removably coupled at a lower end to the vehicle frame front cross-member and removably coupled at an upper end to a vehicle frame rear cross-member to distribute a load on the actuator between the upper and the lower cross members and prevent twisting of the lower cross-member.

7. The assembly of claim 6, wherein the actuator comprises a clevis joint including a pin removably inserted through the actuator upper end and a pair of opposing apertures in opposing legs of the C-channel to removably connect the actuator upper end to the C-channel.

8. The assembly of claim 6, wherein the frame brace comprises:
a hat-channel coupled to the vehicle frame front cross-member to distribute the load across the vehicle frame front cross-member; and
a clevis joint including a dowel pin removably inserted through the actuator lower end and a pair of opposing apertures in opposing arms of the hat-channel the lower end of the frame brace to removably couple the actuator to the hat-channel.

9. The assembly of claim 8, wherein the hat-channel includes a coupling tab at each of opposing ends for removably coupling the hat-channel to the vehicle frame front cross-member.

10. The assembly of claim 6, wherein the actuator comprises a brake mechanism to hold an actuator lift rod at any desired linear translation position.

11. The assembly of claim 6, wherein the actuator is mounted to the bed platform and the vehicle frame front cross-member at an angle such that a force required by the actuator to initially lift the cargo bed is approximately 100% to 115% of a minimal amount of force needed to initially lift the cargo bed, and such that a change in the angle as the bed is lifted by the actuator is between approximately 0° and 10°.

12. The assembly of claim 11, wherein the actuator is mounted at an angle of approximately 40° to 50° relative to the underside of the cargo bed when the cargo bed is in a non-deployed position.

13. A light-weight utility vehicle comprising:
a cargo bed; and
a cargo bed lift assembly for lifting a front end of the cargo bed, the lift assembly comprising:
a bed platform coupled to an underside of a cargo bed for supporting the cargo bed;
an electric actuator removably mounted at an upper end to the bed platform, and removably mounted at a lower end to a vehicle frame front cross-member located below a front portion of cargo bed; and
a frame brace removably coupled at a lower end to the vehicle frame front cross-member and removably coupled at an upper end to a vehicle frame rear cross-member to distribute a load on the actuator between the upper and the lower cross members and prevent twisting of the lower cross-member.

14. The vehicle of claim 13, wherein the bed platform comprises a center C-channel connected to the underside approximately along the longitudinal center of the cargo bed, the actuator upper end removably connected to the C-channel via a clevis joint including a dowel pin removably inserted through the actuator upper end and a pair of opposing apertures in opposing legs of the C-channel.

15. The vehicle of claim 13, wherein the lower end of the frame brace comprises a hat-channel coupled to the vehicle frame front cross-member to distribute the load across the vehicle frame front cross-member, the actuator lower end removably coupled to the hat-channel via clevis joint including a dowel pin removably inserted through the actuator lower end and a pair of opposing apertures in opposing arms of the hat-channel.

16. The vehicle of claim 15, wherein the hat-channel includes a coupling tab at each of opposing ends for removably coupling the hat-channel to the vehicle frame front cross-member.

17. The vehicle of claim 13, wherein the actuator comprises a brake mechanism to hold an actuator lift rod at any desired linear translation position.

18. The vehicle of claim 13, wherein the actuator is mounted to the bed platform and the vehicle frame front cross-member at an angle such that a force required by the actuator to initially lift the cargo bed is approximately 100% to 115% of a minimal amount of force needed to initially lift the cargo bed, and such that a change in the angle as the bed is lifted by the actuator is between approximately 0° and 10°.

19. The vehicle of claim 18, wherein the actuator is mounted at an angle of approximately 40° to 50° relative to the underside of the cargo bed when the cargo bed is in a non-deployed position.
